(19) United States
(12) Patent Application Publication
(10) Pub. No.: US 2003/0037979 A1
(43) Pub. Date: Feb. 27, 2003

(54) Truck with notched cab

(76) Inventor: Dennis A. Schwalbe, Muenster, TX (US)

Correspondence Address: James E. Bradley, Bracewell & Patterson, LLP, P.O. Box 61389, Houston, TX, 77208-1389, US

(21) Appl. No.: 09/938,005

(22) Filed: Aug. 23, 2001

(51) Int. Cl. B62D 33/08

(52) U.S. Cl. 180/89.14

(57) ABSTRACT

A fire truck cab mounts over an engine and tilts forward for access to the engine. The truck has a cab has a notched rear wall, the notch being a vertically-extending recess. A vertical component stack mounts to the truck frame and fits within the notch when the cab is lowered. The component stack includes various components that are typically carried under the cab, such as an air filter, a hydraulic reservoir and a radiator-fluid expansion tank. The cab has rear or jump seats that are located alongside and no higher than the truck frame.

### BACKGROUND OF THE INVENTION

1. Field of the Invention

The present invention relates in general to trucks, and more particularly to a cab for a fire truck having a notched area in a rear wall for engine air intake and a low rear passenger seating arrangement.

2. Description of the Prior Art

The cabs of trucks, especially fire trucks, are typically designed to carry a number of people and their equipment, the cabs having many seating configurations. A common configuration for a cab over fire truck is one in which a driver and front passenger face forward in a forward portion of the cab, whereas additional passengers sit in jump seats in a rear portion of the cab. These jump seats may face forward or rearward or may be sets of opposed sets that face one another. Typically, the back wall of the cabs are generally flat, allowing for placement of seats across the length of the back wall.

It is necessary for the seats in the forward portion of the cab to be located a large height from the ground because of their location over or near the engine of the truck and/or related components. Likewise, typical cab configurations locate the rear passengers high above the ground in order to clear additional engine-related components located below the rear portion of the cab. These components include such items as the air filter/intake and various fluid overflow/fill tanks. The passenger seats will be well above the longitudinal frame members of the truck frame.

Because of the height of the rear seats, it is necessary to provide steps or ladders for use in entering and exiting the truck, presenting a danger to the rear-seat passengers. Also, the height of the rear seats results in a considerable overall height for the truck cab. A lower truck cab is desirable for clearance purposes.

### SUMMARY OF THE INVENTION

The truck cab of this invention is a cab-over type that has a rear section for carrying passengers. The truck a cab having a notched rear wall, the notch extending vertically from the lower edge to the roof of the cab. A vertical structure fits within the external notch or recess and comprises various components. The components include an engine-air intake conduit and may also include a radiator-coolant overflow container and a hydraulic-fluid container. The location of these components within the notch allows for a lower seating position for rear-seat passengers. The platforms for the rear seats are located on each side of the longitudinal frame members of the truck, and are preferably no higher than the longitudinal frame members.

### DESCRIPTION OF THE DRAWINGS

The novel features believed to be characteristic of the invention are set forth in the appended claims. The invention itself however, as well as a preferred mode of use, further objects, and advantages thereof, will best be understood by reference to the following detailed description of an illustrative embodiment when read in conjunction with the accompanying drawings.

FIG. 1 is a schematic profile view of a truck having a cab constructed in accordance with the present invention.

FIG. 2 is a schematic plan view of the truck of FIG. 1.

FIG. 3 is a schematic cross-sectional view of the truck of FIG. 1 along the section line 3-3.

FIG. 4 is a perspective view of the truck of FIG. 1 showing the cab in a raised position.

FIG. 5 is a schematic cross-sectional view of the truck of FIG. 1 along the section line 5-5.

### DESCRIPTION OF THE INVENTION

FIGS. 1 through 5 illustrate the preferred embodiment of a truck having a cab notched to receive a component stack. The advantage to using the vertical stack is that components are removed from beneath the cab, allowing the rear-seat passengers to be located lower in the cab.

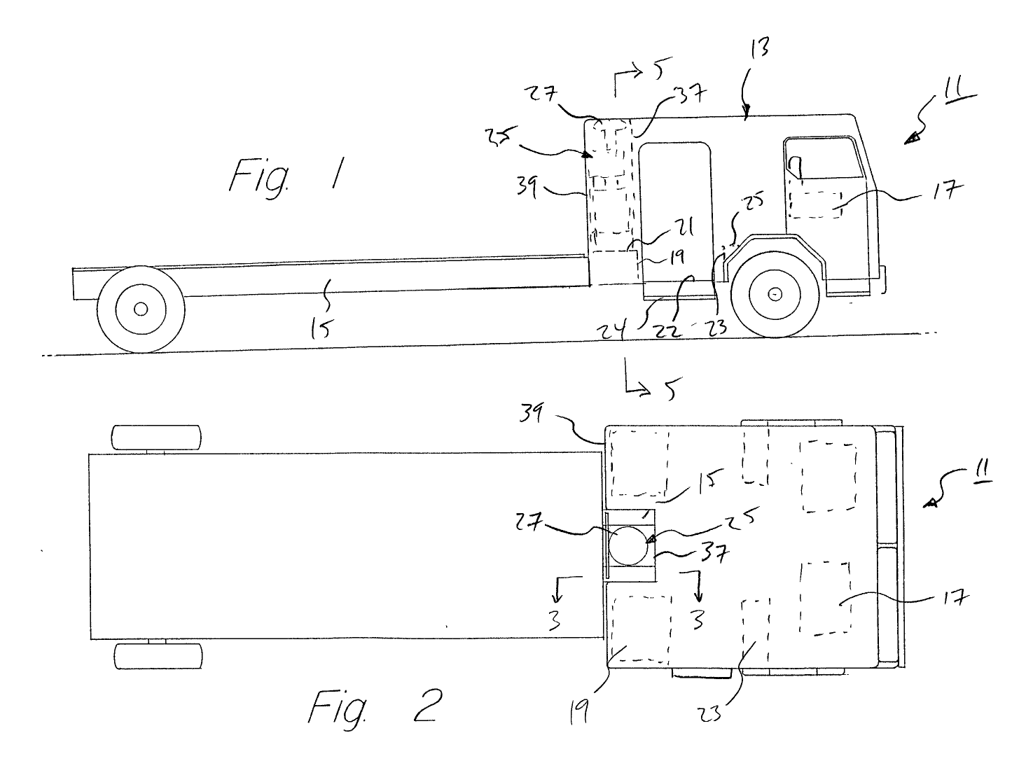

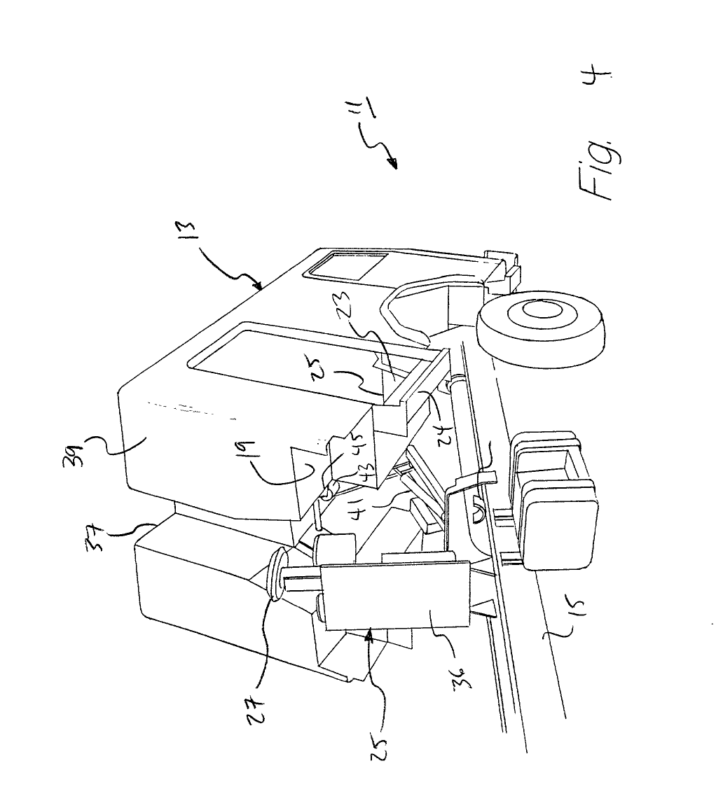

FIGS. 1 and 2 show a truck 11 having a cab 13 of a type that locates over the engine. Cab 13 is located near the forward portion of longitudinal frame rails 15 that extend for the length of truck 11. Frame rails 15 are parallel and are each located laterally from the longitudinal centerline of truck 11. Cab 13 is pivotally mounted to frame rails 15, allowing cab 13 to be moved from a lowered, in-use position to tilted or raised position that provides access to the engine area of truck 11. This tilting arrangement is shown in FIG. 4, which is discussed below.

FIGS. 1 and 2 also show the seating arrangement for front- and rear-seat passengers in truck 11. Front seats 17 are located within cab 13 and on each side of the longitudinal centerline of truck 11. The height of front seats 17 is substantially above the upper portion of frame rails 15, requiring front-seat passengers to climb upward to reach front seats 17. In the past, as described above, rear passengers are also required to climb to seats located above frame rails 15 at approximately the same height as front-seat passengers. However, the present invention allows for rear jump seats 19 to be lowered. The height of the platforms 21 for rear jump seats 19 are near but preferably no greater than the height of the upper surfaces of frame rails 15. Each platform 19 is located laterally outward of one of the frame rails 15. A cushion, which may include a shock absorbing mechanism, will be mounted to each seating platform 19. Each seating platform 21 is located above a floor surface 22 for receiving the feet of the passengers. The passengers in rear jump seats 19 will face forward. Cab 13 has a tunnel portion that fits over frame rails 15 and various components of the engine. Each rear jump seat 19 extends downward from the tunnel portion so that it will be closely spaced to the outer side of one of the frame rails 15.

Cab 13 may also have forward jump seats 23, which are located forward of and opposed to rear jump seats 19. The passengers in forward jump seats 23 will face rearward and share the same floor surface 22 for their feet. Forward jump seats 23 have horizontal platforms 25 that are preferably located approximately the same height as seating surfaces 21 of rear jump seats 19. Each forward jump seat platform 25 is located laterally outward of one of the frame rails 15. A cushion, including a spring or shock supporting mechanism may be mounted to each forward jump seat platform 25.

Because of their lowered position, rear passengers need only use step 24 to step into cab 13 and onto jump seats 19,21, reducing the height and the corresponding risk to rear passengers when entering and exiting truck 11. As shown in FIG. 2, seats 17, 19, 23 are arranged on each side of the longitudinal centerline of truck 11. FIG. 5 also illustrates the height of rear jump seats 19 and seating platforms 21 relative to frame rails 15.

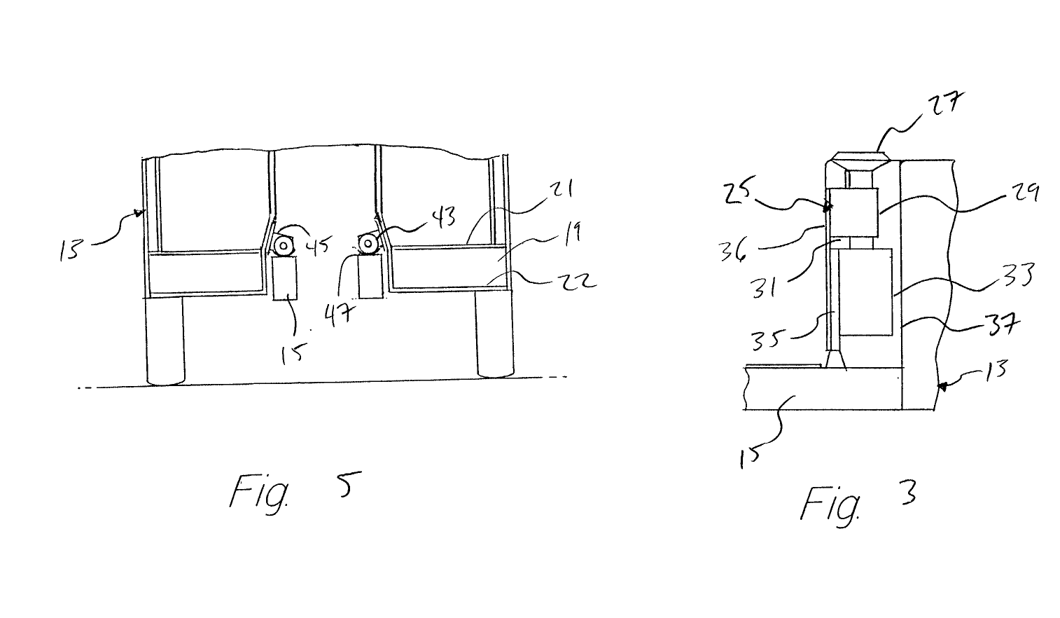

A vertical component stack 25 is located generally along the longitudinal centerline of truck 11 and extends upward perpendicular to frame rails 15. As shown in detail in FIG. 3, the preferred embodiment of component stack 25 comprises an air filter 27 for the engine, a hydraulic-fluid reservoir 29 for the truck, a radiator expansion or overflow tank 31 for the engine radiator, and an airbox 33, though component stack 25 may have less or additional components. Component stack 25 is mounted to frame rails 15 using brackets 35 and may have a vertical cover plate 36 mounted on the rear portion of stack 25. Each component of component stack 25 is connected to the engine or other associated portions of truck 11 by horizontally extending conduits. The uppermost component of component stack 25 is preferably about the same height above the ground as the roof of truck cab 13 while in its operational position. In this embodiment, the uppermost component is air filter 27.

Referring also to FIGS. 1 and 2, to provide clearance for component stack to fit with the outer perimeter of cab 13, a notch or recess 37 is formed in rear wall 39 of cab 13. Notch 37 is generally rectangular, when viewed in plan view (FIG. 2), and extends vertically through the entire height of cab 13. Notch 37 results in a generally U-shaped configuration for rear wall 39. The components 27, 29, 31, 33 on component stack 25 are arranged so that component stack 25 will fit within notch 37 and that cover plate 36 is co-planar with rear wall 39 when cab 13 is in the lowered position. Component stack 25 is no farther rearward than rear wall 39.

Depending on the desired use, additional structure (not shown) will be mounted to frame rails 15 rearward of cab 13. One use of truck 11 is for fire fighting. In such case, conventional pumping equipment will be mounted to frame rails 15 rearward of cab 13. Such pumping equipment is located within a body that has a forward edge spaced close to rearward wall 39 of cab 13.

FIG. 4 illustrates the tilting capability of cab 13. Cab 13 is pivotally mounted to a forward portion of frame rails 15. Because of the weight of cab 13, a hydraulic ram 41 is used to move cab 13 between the lowered position (FIGS. 1 through 3, 5) and the raised position (FIG. 4). When cab 13 is raised, as shown, component stack 25 remains in a fixed position, notch 37 clearing component stack 25 as cab 13 is raised.

Referring still to FIG. 4, load bearing members, such as rollers 43, are mounted to a lower rear portion of cab 13 using brackets 45. When cab 13 is lowered to be generally parallel to frame rails 15, rollers 43 rest on cradles 47, cradles 47 being mounted on frame rails 15. Rollers 43 and cradles 47 ensure that cab 13 is located in the desired position when in the in-use, lowered position. The weight of the rear portion of cab 13 transfers through rollers 43 and cradles 47 to frame rails 15. This orientation is shown in FIG. 5, with rollers 43 carried in cradles 47 on frame rails 15.

One advantage of the present invention is that the rear passenger seats of a truck cab are located at a lower height than in prior art configurations. This allows more convenient and safer access to and from the seats. Placing the seats alongside the frame rails, rather than above, allows the overall height of the cab to be lower than would otherwise be required. The notch in the rear portion of the cab positions the vertical component stack no farther rearward than the rearward wall of the cab. The body that locates on the frame rails rearward of the cab thus can be of a full length without increasing the length of the frame rails. No space along the frame rails is lost due to the vertical component stack. Tilting the cab provides ready access to the components in the vertical component stack.

While the invention has been shown in only one of its forms, it is not thus limited but is susceptible to various changes and modifications without departing from the scope thereof.

I claim:

1. A truck comprising:
a pair of longitudinally-extending frame rails;
a cab carried by the frame rails of a truck, the cab having a rear wall with a notch extending from a lower edge to a roof of the cab;
a component stack mounted to and extending upward from the frame rails, the component stack including an air filter for an engine of the truck and being sized to fit within the notch; and
a plurality of jump seats located in a rearward portion of the cab, each of the jump seats being located alongside and laterally outward of each of the frame rails.

2. The truck of claim 1, wherein:
each jump seat has a seating platform located at a height no greater than upper surfaces of the frame rails.

3. The truck of claim 1, wherein:
the cab is pivotally mounted to the frame rails for tilting between a lowered position and a raised position; and
the component stack is stationarily mounted to the frame rails.

4. The truck of claim 1, wherein:
the jump seats comprise forward jump seats and rear jump seats that are arranged in opposing pairs on each lateral side of the cab.

5. The truck of claim 1, wherein:
the component stack further comprises at least one fluid tank.

6. The truck of claim 1, further comprising:
front passenger seats located in a forward portion of the cab, each of the front passenger seats having a seating platform located at a height above the upper surfaces of the frame rails.

7. The truck of claim 1, wherein:
the notch is centered along the rear wall of the cab.

8. A truck comprising:
a pair of longitudinal frame rails;
a cab pivotally mounted to the frame rails of the truck for tilting between a lowered position and a raised position, the cab having a rear wall containing a vertically-extending notch substantially centered between lateral side walls of the cab;
a vertical component stack mounted to the frame rails and sized to fit within the notch when the cab is in the lowered position, the component stack including an air filter for an engine of the truck;
front passenger seats located in a forward portion of the cab, each of the front passenger seats having a seating platform located above the frame rails when the cab is in the lowered position; and
jump seats located in a rearward portion of the cab, each of the jump seats having a seating platform that is located along an outer side of one of the frame rails and lower than the seating platforms of the front passenger seats when the cab is in the lowered position.

9. The truck of claim 8, wherein:
the seating platforms of the jump seats are no higher than the frame rails when the cab is in the lowered position.

10. The truck of claim 8, wherein:
the jump seats comprise forward jump seats and rear jump seats that are arranged in opposing pairs on each of the lateral sides of the cab.

11. The truck of claim 8, wherein:
the component stack further comprises an expansion container for a radiator of the truck.

12. A driver and passenger compartment for a fire truck, comprising:
a cab adapted to be pivotally mounted to longitudinal frame rails of a truck for tilting between a lowered position and a raised position;
the cab having a rear wall containing a vertically-extending recess extending substantially centered between lateral side walls of the cab for receiving a vertical component stack of the fire truck;
a pair of front passenger seats located in a forward portion of the cab, each of the front passenger seats having a seating platform; and
a pair of forward facing jump seats located in a rearward portion of the cab, each of the forward facing jump seats having a seating platform that is located outward of the recess and lower than the seating platforms of the front passenger seats.

13. The truck cab of claim 12, further comprising:
a pair of rearward facing jump seats mounted forward of and opposed to the forward facing jump seats, the of the rearward facing jump seats having a seating platform located lower than the seating platforms of the front passenger seats.
